(19) United States
(12) Patent Application Publication
(10) Pub. No.: US 2019/0213813 A1
(43) Pub. Date: Jul. 11, 2019

(54) TOUCH ISOLATED ELECTRONIC LOCK

(71) Applicant: Spectrum Brands, Inc., Middleton, WI (US)

(72) Inventors: Gerald Chong, Mission Viejo, CA (US); Thomas P. Morse, Wyomissing, PA (US); Alan Uyeda, Irvine, CA (US)

(21) Appl. No.: 16/239,773

(22) Filed: Jan. 4, 2019

Related U.S. Application Data
(60) Provisional application No. 62/613,944, filed on Jan. 5, 2018.

(51) Int. Cl. G07C 9/00; E05B 47/00

(52) U.S. Cl. CPC G07C 9/00182; E05B 2047/0014; E05B 47/0001

(57) ABSTRACT

An electronic lock includes a latch assembly that has a latch housing and a bolt. The bolt is movable between an extended position and a retracted position. The electronic lock includes a controller connected to a circuit board. The controller is configured to electronically control movement of the bolt between the extended position and the retracted position. The electronic lock includes an exposed conductive touch member. The conductive touch member is in electrical communication with the controller. The electronic lock includes an insulating arrangement positioned between the conductive touch member and the circuit board. The electronic lock includes a housing at least partially surrounding the conductive touch member. The housing is electrically isolated from the conductive touch member by at least a portion of the insulating arrangement.

### CROSS-REFERENCE TO RELATED APPLICATIONS

This application claims the benefit of U.S. Provisional Application No. 62/613,944, filed Jan. 5, 2018, the disclosure of which is hereby incorporated herein by reference.

### BACKGROUND

Electronic locks have gained increasing acceptance and widespread use in residential and commercial markets. These locksets control ingress through doors in a building by requiring certain electronic credentials. For example, these locksets typically include a control circuit that determines whether to unlock the lockset based on credentials provided by the user. In some cases, for example, the credentials and/or commands may be provided wirelessly to the lockset, as disclosed in U.S. Pat. No. 9,336,637 for a “Wireless Access Control System and Related Methods,” which is hereby incorporated by reference in its entirety. In some examples, the electronic lock can sense credentials held by a nearby, authorized user and require the user to physically touch the lock to activate the lock, as disclosed in U.S. Pat. No. 9,024,759 for a “Wireless Lockset with Integrated Antenna, Touch Activation, and Light Communication Method,” which is hereby incorporated by reference in its entirety.

The physical appearance of the lockset is important to some users. Some users prefer all the hardware in their home to match, or at least be from the same style line. Typically, with traditional non-electronic locks, this was accomplished by changing out a trim or facade of a lockset. However, when using a touch-activated lockset, maintaining a proper seal around internal electronics and ensuring reliable touch activation makes a lockset housing swap difficult.

Therefore, improvements in electronic lock design are desired.

### SUMMARY

The present disclosure relates generally to door locks. In one possible configuration, and by non-limiting example, an electronic lock with an isolated touch member and an outer housing is disclosed.

In one example of the present disclosure, an electronic lock is disclosed. The electronic lock includes a latch assembly that has a latch housing and a bolt. The bolt is movable between an extended position and a retracted position. The electronic lock includes a controller connected to a circuit board. The circuit board is positioned within an interior cavity. The cavity is at least partially defined by the latch housing. The controller is configured to electronically control movement of the bolt between the extended position and the retracted position. The electronic lock includes an exposed conductive touch member. The conductive touch member is in electrical communication with the controller. The electronic lock includes an insulating arrangement positioned between the conductive touch member and the circuit board. The electronic lock includes a housing at least partially surrounding the conductive touch member. The housing is electrically isolated from the conductive touch member by at least a portion of the insulating arrangement.

In another example of the present disclosure, an electronic lock is disclosed. The electronic lock includes a latch assembly that has a latch housing and a bolt. The bolt is movable between an extended position and a retracted position. The electronic lock includes a controller mounted to a circuit board. The circuit board is positioned within an interior cavity. The cavity is at least partially defined by the latch housing. The controller is configured to electronically control movement of the bolt between the extended position and the retracted position. The electronic lock includes an exposed conductive touch member. The conductive touch member is in electrical communication with the controller. The electronic lock includes an insulating arrangement positioned between the conductive touch member and the circuit board. The insulating arrangement includes a translucent portion configured to transmit light and at least one seal. The translucent portion at least partially defines the interior cavity. The translucent portion is at least partially exposed adjacent the touch member. The at least one seal is positioned between at least one of the translucent portion and the latch housing and the translucent portion and touch member to seal the interior cavity. The electronic lock includes a housing at least partially surrounding the conductive touch member. The housing is electrically isolated from the conductive touch member by at least a portion of the insulating arrangement.

In another example of the present disclosure, an electronic lock is disclosed. The electronic lock includes a latch assembly that has a latch housing and a bolt. The bolt is movable between an extended position and a retracted position. The electronic lock includes a controller mounted to a circuit board. The circuit board is positioned within an interior cavity. The cavity is at least partially defined by the latch housing. The controller is configured to electronically control movement of the bolt between the extended position and the retracted position. The electronic lock includes an exposed conductive touch member. The conductive touch member is in electrical communication with the controller via a conductor. The electronic lock includes an insulating arrangement positioned between the conductive touch member and the circuit board. The insulating arrangement includes a body at least partially defining the interior cavity. The body defines an aperture that is configured to receive the conductor. A first seal of the insulating arrangement surrounds the aperture. The electronic lock includes a housing at least partially surrounding the conductive touch member. The housing is electrically isolated from the conductive touch member by at least a portion of the insulating arrangement.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic perspective view of an electronic lock, according to one example of the present disclosure.

FIG. 2 is a rear perspective view of an exterior assembly of the electronic lock of FIG. 1.

FIG. 3 is a front view of the exterior assembly of the electronic lock of FIG. 1.

FIG. 4 is a rear view of the exterior assembly of the electronic lock of FIG. 1.

FIG. 5 is a cross-sectional view along line 5-5 in FIG. 3 of the exterior assembly of the electronic lock of FIG. 1.

FIG. 6 is a cross-sectional view along line 6-6 in FIG. 3 of the exterior assembly of the electronic lock of FIG. 1.

FIG. 7 is an exploded view of the exterior assembly of the electronic lock of FIG. 1.

FIG. 8 is a schematic perspective view of an electronic lock, according to one example of the present disclosure.

FIG. 9 is a rear perspective view of an exterior assembly of the electronic lock of FIG. 8.

FIG. 10 is a front view of the exterior assembly of the electronic lock of FIG. 8.

FIG. 11 is a rear view of the exterior assembly of the electronic lock of FIG. 8.

FIG. 12 is a cross-sectional view along line 12-12 in FIG. 10 of the exterior assembly of the electronic lock of FIG. 8.

FIG. 13 is a cross-sectional view along line 13-13 in FIG. 10 of the exterior assembly of the electronic lock of FIG. 8.

FIG. 14 is an exploded view of the exterior assembly of the electronic lock of FIG. 8.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

This disclosure generally relates to an electromechanical lock with certain features. The term “electronic lock” is broadly intended to include any type of lockset that uses electrical power in some manner, including but not limited to, electronic deadbolts, electronic lever sets, etc. This disclosure encompasses the integration of one or more of features described herein into any type of electronic lock and is not intended to be limited to any particular type of electronic lock.

The electronic lock disclosed herein includes a plurality of advantages. The lock provides an isolated touch member that is used to selectably operate the electronic lock between a locked and unlocked state. By isolating the touch member, an exposed outer housing can be selectively interchanged (either at the time of manufacture or retrofit after the lock has been installed) with a variety of different outer housings to suit the preference of the user without effecting the operation of the electronic lock. Specifically, the touch member is electronically isolated from the outer housing via an insulating arrangement. In some examples, the insulating arrangement can include at least one seal. In other examples, the insulating arrangement includes a translucent portion that is configured to convey light to indicate the status of the lock. In some examples, the insulating arrangement weatherproofs the lock so that internal electronics (e.g., a circuit board and/or controller) are protected from the elements, such as water.

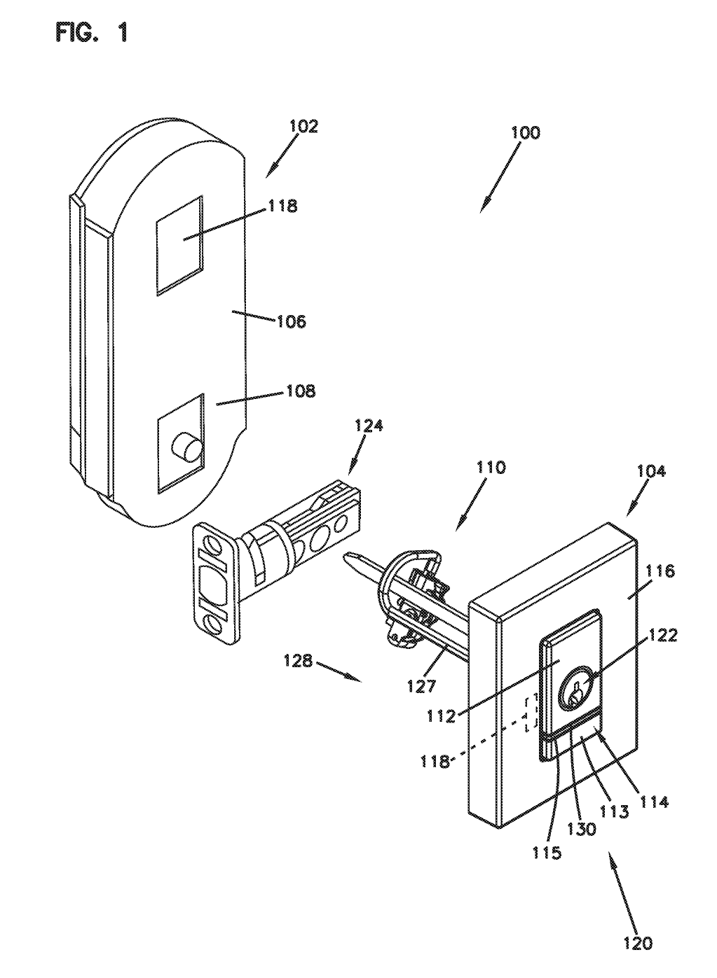

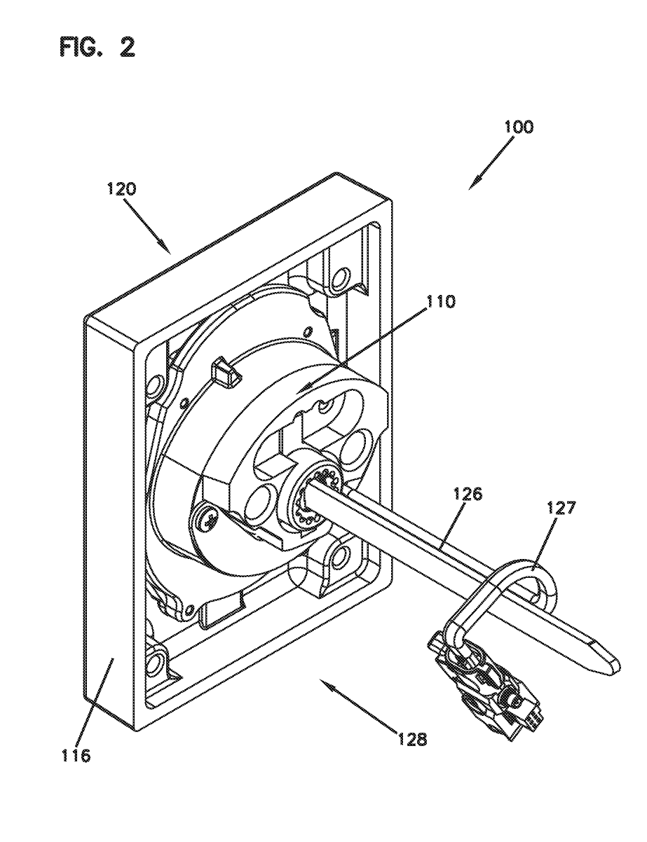

FIG. 1 shows a partially exploded electronic lock 100, according to one example of the present disclosure. FIG. 2 shows a rear perspective view of a portion of the lock 100. The lock 100 includes an interior assembly 102 and an exterior assembly 104. The interior assembly 102 can include a housing 106 and a driver 108. The exterior assembly 104 can include a latch assembly 110, a conductive touch member 112, an insulating arrangement 114, and an outer housing 116. The lock 100 further includes a controller 118 that can be positioned within the interior or exterior assemblies 102, 104.

In some examples, the exterior assembly 104 is mounted on the outside of a door (not shown), while the interior assembly 102 is mounted inside a door. The latch assembly 110 is typically at least partially mounted in a bore formed in the door. The term “outside” is broadly used to mean an area outside a door and “inside” is also broadly used to denote an area inside a door. With an exterior entry door, for example, the exterior assembly 104 may be mounted outside a building, while the interior assembly 102 may be mounted inside a building. With an interior door, the exterior assembly may be mounted inside a building, but outside a room secured by the lock 100; the interior assembly 102 may be mounted inside the secured room. The lock 100 is applicable to both interior and exterior doors.

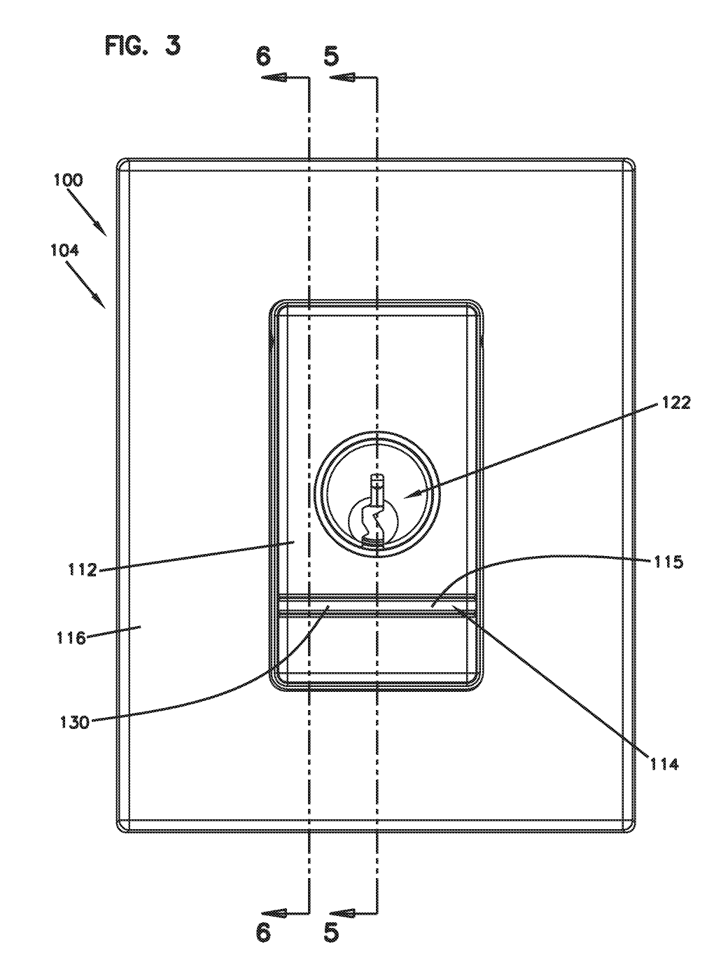

When installed in a door (not shown), at least the touch member 112 and the outer housing 116 are exposed to the user at a front portion 120 of the lock 100 at the exterior of the door, as shown in FIG. 3. In some examples, a portion of the insulating arrangement 114 is also exposed to the user. To interact with the lock 100, the user can use a key (not shown) to operate the lock 100 via a mechanical locking assembly 122 and/or provide a touch input to the conductive touch member 112, that is in communication with the controller 118, to electronically operate the lock 100. If the user provides a touch input to the outer housing 116, the lock 100 will not electronically operate (even if the user possesses authenticated credentials).

In the depicted example, the latch assembly 110 includes a bolt 124 that may be actuated manually by the mechanical lock assembly 122, or electronically via the touch member 112 and controller 118 to extend/retract the bolt 124. The bolt 124 is configured to slide longitudinally and when the bolt 124 is retracted, the door is in an unlocked state. When the bolt 124 is extended, the bolt 124 protrudes from the door into a door jamb (not shown) to place the door in a locked state.

The latch assembly 110 also includes an extension 126 that extends from a rear portion 128 of the lock 100. The extension 126 is configured to interface with the bolt 124 and with the interior assembly 102. In some examples, the extension 126 may be driven to extend/retract the bolt 124 in several ways. For example, the mechanical lock assembly 122 could be actuated by a mechanical key to rotate the extension 126, which would allow the bolt 124 to be extended/retracted. The exterior assembly 104 could be used to electronically actuate the latch assembly 110 by providing a touch input to the touch member 112 (assuming the lock 100 received authenticated credentials prior to the user touching the touch member 112). In some examples, by providing a touch input to the touch member 112 to actuate the bolt 124, a message is sent from the exterior assembly 104 to the interior assembly 102 using a wiring harness 127 to actuate the driver 108 in the interior assembly 102 that drives the extension 126. Additionally, if the user is inside the door, a turn piece (not shown) could be manually rotated by the user to actuate the extension 126, thereby moving the bolt 124 between its extended and retracted positions.

As noted above, the touch member 112 is configured to enable the lock 100 to be touch activated. For example, the lock 100 may use capacitive sensing to determine whether the user wants to actuate the lock 100. In some examples, the touch member 112 can be the only surface on the exterior assembly 104 that is used for capacitive sensing to actuate the lock assembly 100. In other examples, other portions of the exterior assembly 104 could be used for capacitive sensing, including but not limited to, a keyway, handle, rose, or other exterior surface of the lock assembly 100 except for the outer housing 116. In the example shown, the exterior assembly 102 uses capacitive sensing to determine when a user touches the touch member 112. Accordingly, in the example shown, the user is able to touch anywhere on the touch member 112 to lock or unlock the lock 100, or otherwise activate various functions of the lock 100.

The touch member 112 can be formed in any size, shape, or from any conductive material. In some examples, the touch member 112 is formed at least partially from zinc. In other examples, the touch member 112 is formed at least partially from brass. In some examples, the lock 100 can include a badge 113 in electrical communication with the touch member 112 or electrically isolated from the touch member 112. In the depicted example, the badge 113 is electrically isolated from the touch member 112.

The insulating arrangement 114 is configured to electrically isolate the touch member 112 from the outer housing 116. In some examples, the insulating arrangement 114 includes a translucent portion 130 configured to convey a light from a light source (not shown) that is viewable by the user at the front portion 120 of the exterior assembly 104. In some examples, as will be further described below, the insulating arrangement 114 can also include at least one seal.

In some examples, the translucent portion 130 of the insulating arrangement 114 is a generally solid body formed from a non-conductive material. In some examples, the translucent portion 130 is formed from a co-molded plastic. In some examples, the translucent portion 130 is formed from Polycarbonate. In some examples, only a portion of the translucent portion 130 is exposed to, and viewable by, the user. In some examples, an exposed portion 115 of the translucent portion 130 at the front 120 of the exterior assembly 104 is a rectangular shape. In some examples, the exposed portion 115 of the translucent portion 130 includes a rectangular shape and a ring shape surrounding the mechanical locking assembly 122.

In some examples, light can be emitted from the translucent portion 130 at regions that could be independently controlled to visually communicate messages to the user, including but not limited to, an action currently being processed by the lock 100, information about the status of the lock 100, and/or requests for user input. By way of example, the translucent portion 130 could visually communicate the direction of bolt movement by illuminating regions in sequence to create a rotation or slide animation showing a direction of movement. The translucent portion 130 can communicate messages to the user by controlling various attributes of the regions, such as turning regions on/off, changing intensity of regions, changing colors illuminated by regions, or other manners of changing the illumination of the translucent portion 130.

The outer housing 116 is at least partially positioned around the insulating arrangement 114 and touch member 112. The outer housing 116 can be of a variety of sizes, shapes, and finishes. In some examples, the outer housing 116 is generally rectangular. In other examples, the outer housing 116 is generally circular. In some examples, the outer housing 116 is removable. For example, an outer housing 116 having a brass finish and a generally rectangular shape can be interchanged (either at the time of manufacture or after the lock 100 has been installed) with an outer housing 116 having a silver finish and a generally circular shape. Because the outer housing 116 is electrically isolated from the touch assembly, outer housings can be cost effectively interchanged either after install of the lock 100 or when the user is purchasing the lock 100. In some examples, this allows for the manufacture of a single exterior assembly 104, sans the outer housing 116, and the manufacture of infinite different outer housings 116 to allow the user to customize the physical look of the lock 100. This allows the user to match the sizes, shapes, and finishes of other hardware in their home or business while still providing a full featured electronic lock.

In some examples, the outer housing 116 can be connected to the rest of the exterior assembly 104 (e.g., the latch assembly 110) via fasteners 132. In other examples, the outer housing 116 can be connected to the rest of the exterior assembly 104 (e.g., the latch assembly 110) via securing tabs or other like tool-less securing solutions. In other examples, the outer housing 116 is connected directly to the door.

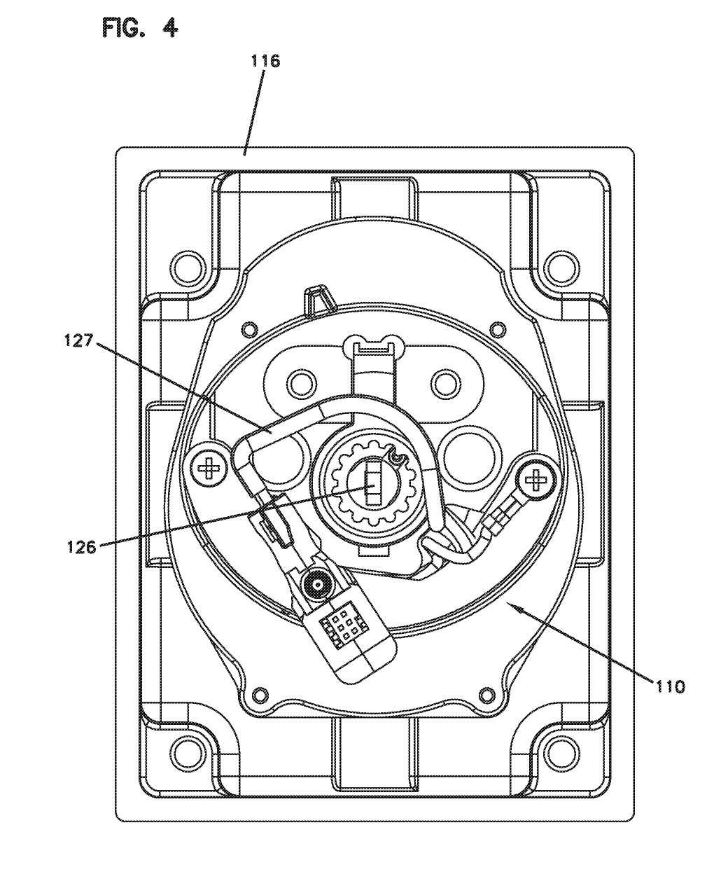

The controller 118 of the lock is configured to be electrically connected to the touch member 112 to selectively control the movement of the bolt 124. In some examples, the controller 118 is mounted within the exterior assembly 104 and/or in the interior assembly 102 and connected to the exterior assembly 104 via the wiring harness 127, which passes through a latch housing 134 of the latch assembly 110 at the rear 128 of the exterior assembly, as shown in FIG. 4.

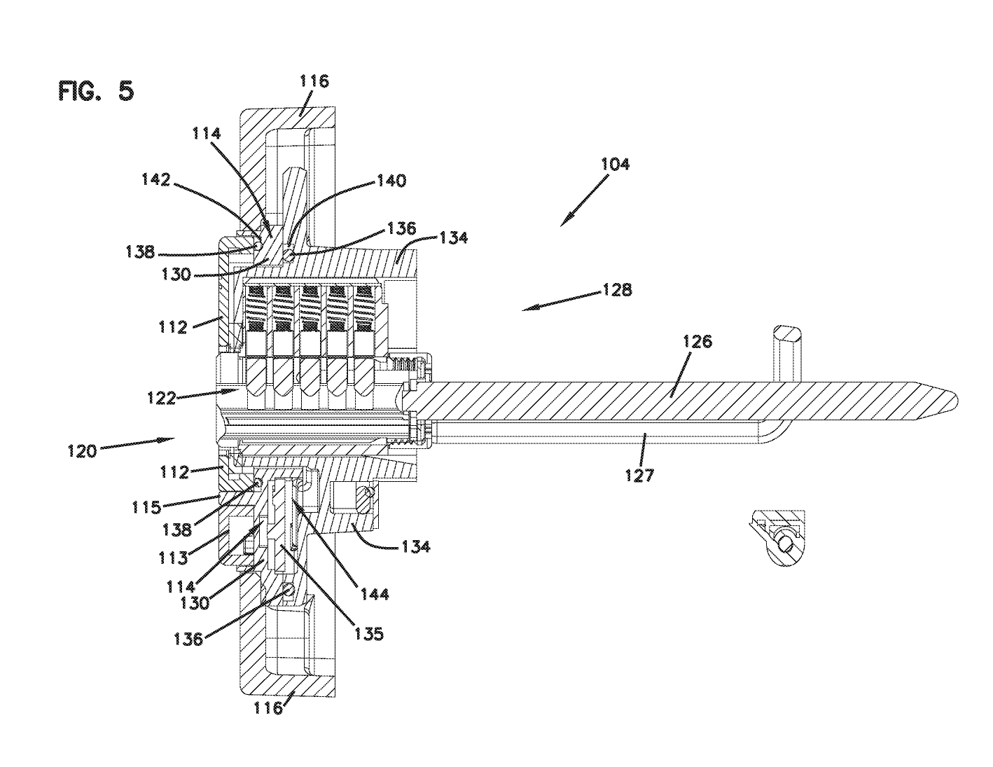

FIG. 5 is a side cross-sectional view of a portion of the exterior assembly 104 along line 5-5 in FIG. 3. As shown, the touch member 112 does not make contact with the outer housing 116. Specifically, the touch member 112 is separated from the outer housing 116 via the insulating arrangement 114. Further shown is a printed circuit board (PCB) 135 positioned within the exterior assembly 104.

The latch assembly 110 is shown to include the mechanical lock assembly 122 and the latch housing 134. The latch housing 134 surrounds the mechanical lock assembly 122. The mechanical lock assembly 122 is shown to be connected to the extension 126.

In the depicted example, the insulating arrangement 114 includes the translucent portion 130, a first seal 136, and a second seal 138. The first seal 136 is positioned between the translucent portion 130 and the latch housing 134. In some examples, the first seal 136 is positioned in a recess 140 defined in the latch housing 134 of the latch assembly 110. The second seal 138 is positioned between the translucent portion 130 and the touch member 112. In some examples, the second seal 138 is positioned in a recess 142 defined by the translucent portion 130. In some examples, the seals 136, 138 are rubber O-rings. However, it is considered within the scope of the present disclosure that the seals 136, 138 can be any of a variety of different types of seals including, but not limited to, sealants, gaskets, or the like.

The PCB 135 is positioned in a cavity 144 formed between the latch housing 134 and the insulating arrangement 114, specifically the translucent portion 130. In some examples, the first and second seals 136, 138 weatherproof the cavity 144 to prevent ingress of moisture into the cavity 144.

The PCB 135 is in electrical communication with the touch member 112 and also in electrical communication with the wiring harness 127. In some examples, the wiring harness 127 connects the PCB with the interior assembly 102. In some examples, the PCB draws power via the wiring harness 127 from the interior assembly 102. In other examples, the PCB 135 can include an on-board power source, such as a battery (not shown).

The PCB 135 can host the touch electronics. In some examples, the PCB includes the controller 118 positioned thereon. The controller 118 can receive touch inputs via the touch member 112 and move the bolt 124 between the extended and retracted positions, respectively.

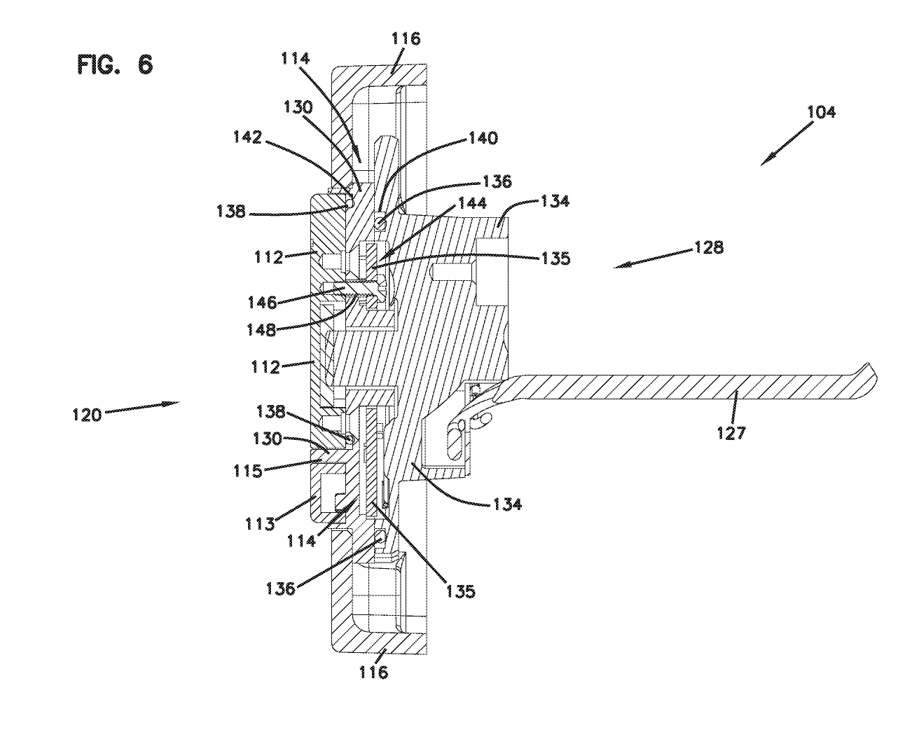

FIG. 6 is a side cross-sectional view of a portion of the exterior assembly 104 along line 6-6 in FIG. 3. As shown, the PCB 135 is positioned within the cavity 144. Further shown is the electrical connection between the PCB 135 and the touch member 112 via a conductor 146.

In this example, the conductor 146 is a conductive fastener connecting the PCB 135 and the touch member 112. The conductor 146 passes through an aperture 148 defined in the insulating arrangement 114. The aperture 148 is positioned at a point on the translucent portion to align with the cavity 144. The first seal 136 surrounds the aperture 148, thereby forming a weatherproof seal, at the side of the aperture 148 that is nearest the cavity 144. The second seal 138 surrounds the aperture 148, thereby forming a weatherproof seal, at the side of the aperture nearest the touch member 112. Therefore, the first and second seals 136, 138 prevent weather (i.e., water) from gaining access to the cavity 144.

The conductor 146 can be any of a variety of conductors to facilitate electrical connection between the touch member 112 and the PCB 135. In the example shown, because the insulating arrangement 114, specifically the translucent portion 130, is formed at least partially of a non-conductive material, the touch member 112 and PCB 135 remain electrically isolated from the outer housing 116.

With the conductor 146, the PCB 135 can sense when a user touches anywhere on the touch member 112. Although a conductive fastener is shown as the conductor 146 for purposes of example, the conductor 146 could be a conductive washer/plate embedded within the translucent portion 130, conductive foam, conductive tape, conductive grease, or any other mechanical device electrically connecting the touch member 112 of the lock 100 to the PCB 135 that hosts the touch electronics. In some examples, the PCB 135 can also be in communication with an antenna embedded within the exterior assembly 104.

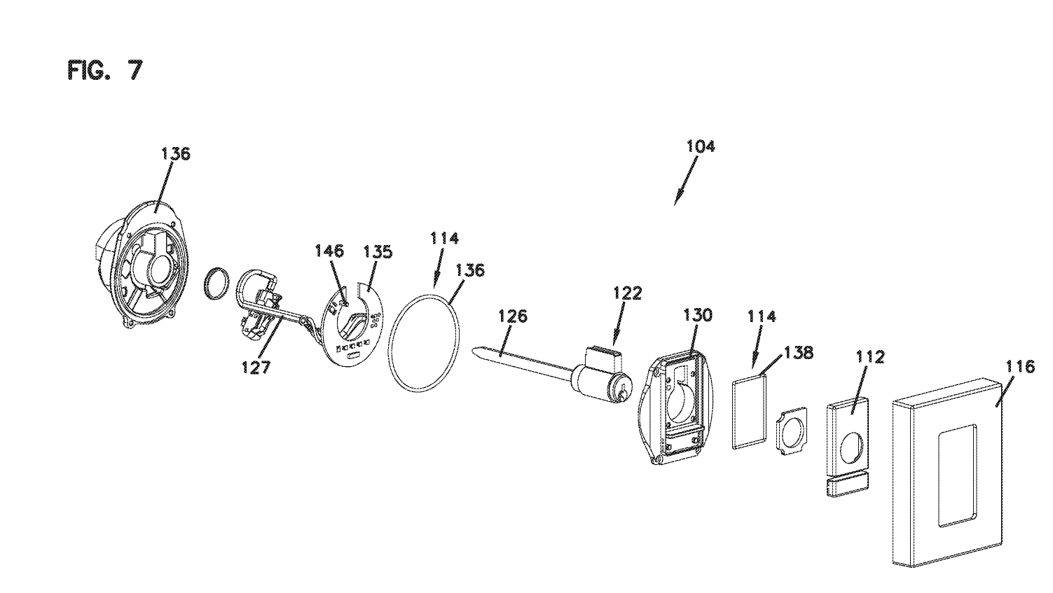

FIG. 7 shows an exploded view of the exterior assembly 104. The exterior assembly 104 is just one example of the exterior assembly. For example, the touch member 112 can be generally circular and the insulating arrangement 114, outer housing 116, latch housing 134, and PCB 135 can be sized and shaped accordingly to accommodate the shape of the touch member 112.

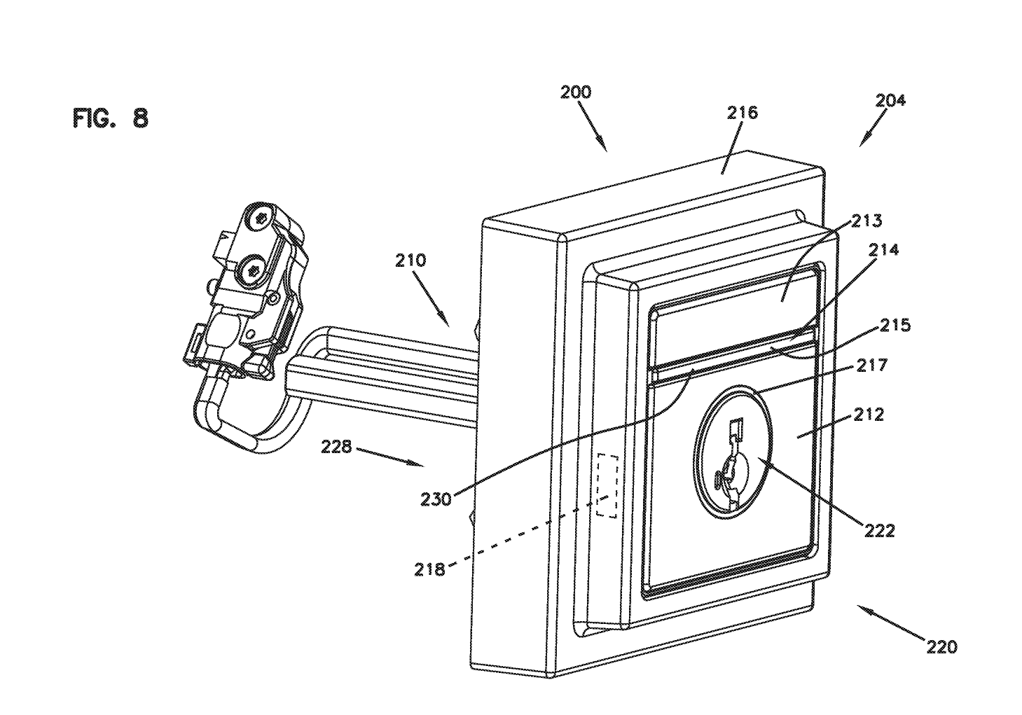

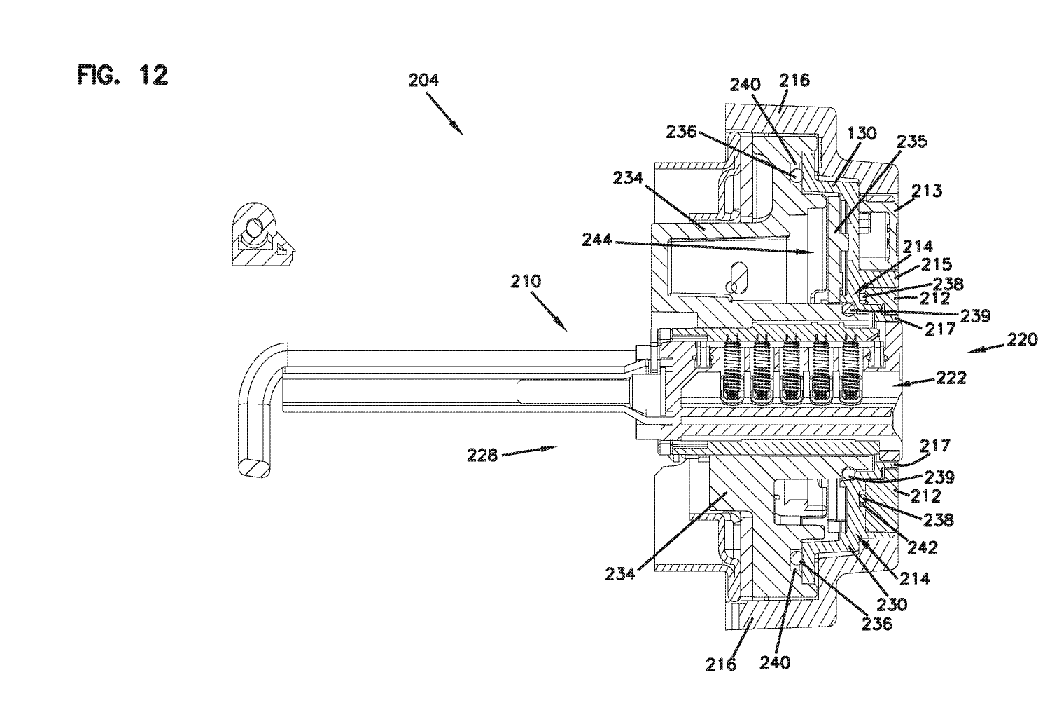

FIGS. 8-14 show an electronic lock 200 according to one example of the present disclosure. The electric lock 200 is substantially similar to the electric lock 100, described above. The electric lock 200 can include an interior assembly and bolt, both substantially similar to the interior assembly 102, and bolt 124 described above. Because of this, only an exterior assembly 204 is shown and described. The exterior assembly 204 is configured to be paired with a bolt, like bolt 124, and an interior assembly, like interior assembly 102, to operate in a substantially similar manner as the electronic lock 100.

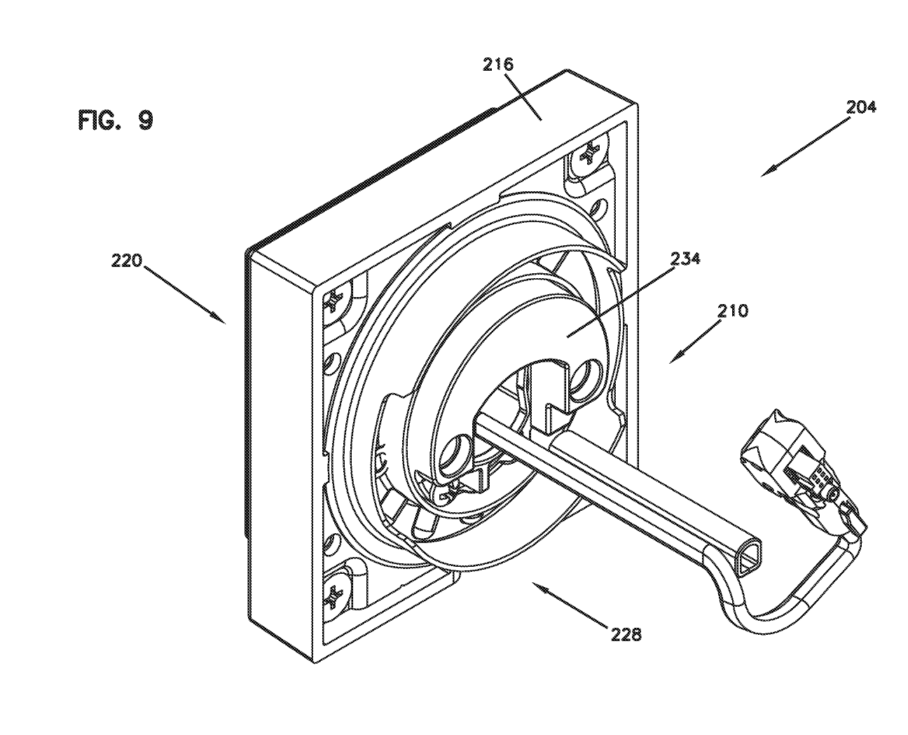

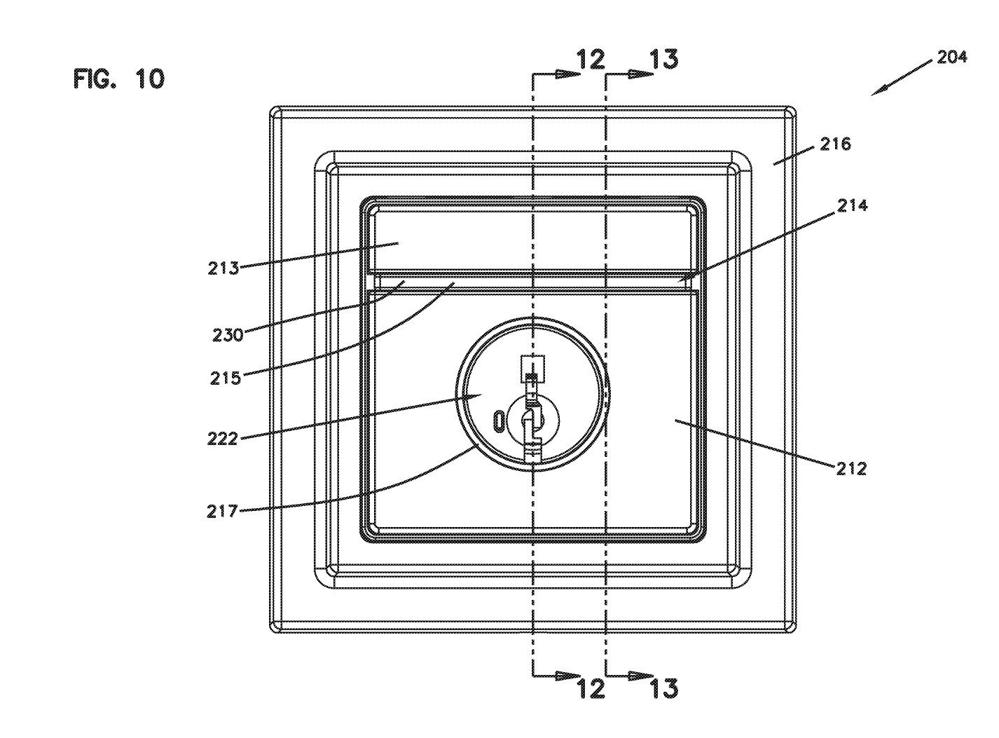

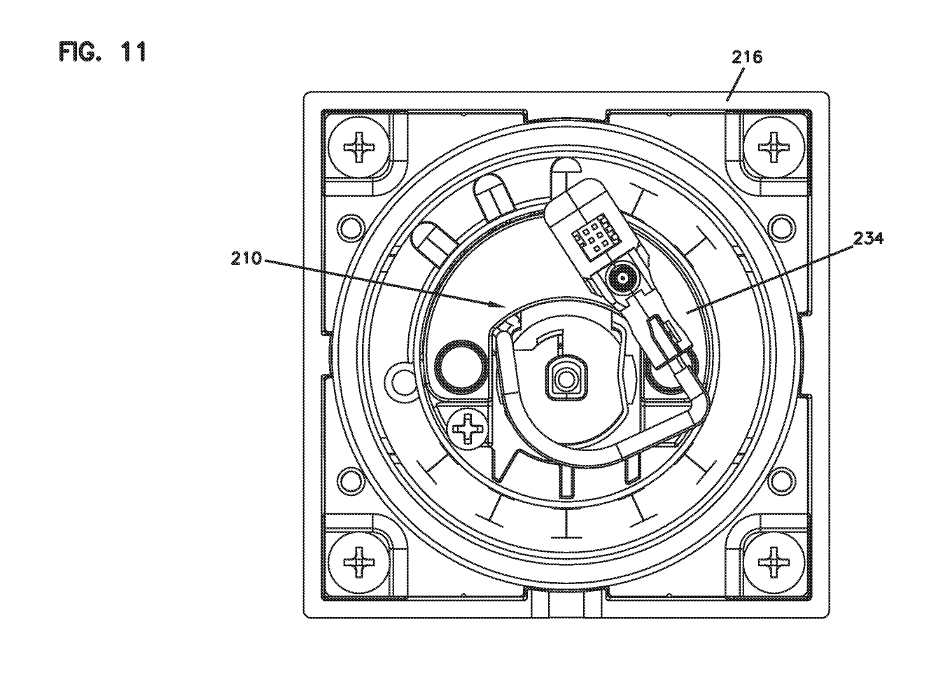

FIG. 8 shows a front perspective view of the exterior assembly 204, and FIG. 9 shows a rear perspective view of the exterior assembly 204. FIG. 10 shows a front view of a front side 220 of the exterior assembly 204, and FIG. 11 shows a rear view of a rear side 228 of the exterior assembly 204.

The exterior assembly 204 of the electronic lock 200 includes a latch assembly 210, a conductive touch member 212, an insulating arrangement 214, and an outer housing 216. The outer housing 216 is electronically isolated from the touch member 212. The lock 200 further includes a controller 218. To interact with the lock 200, the user can use a key (not shown) to operate the lock 200 via a mechanical locking assembly 222 and/or provide a touch input to the conductive touch member 212, that is in communication with the controller 218, to electronically operate the lock 200. If the user provides a touch input to the outer housing 216, the lock 200 will not electronically operate (even if the user possesses authenticated credentials).

The outer housing 216 is at least partially positioned around the insulating arrangement 214 and touch member 212. The outer housing 216 can be of a variety of sizes, shapes, and finishes. In some examples, the outer housing 216 is generally rectangular. In other examples, the outer housing 216 is generally circular. In some examples, the outer housing 216 is removable. For example, an outer housing 216 having a first finish and a first shape can be interchanged (either at the time of manufacture or after the lock 200 has been installed) with an outer housing 216 having a second finish and/or a second shape.

Like the insulating arrangement 114 described above, the insulating arrangement 214 includes a translucent portion 230 and a plurality of seals. Specifically, the insulating arrangement 214 includes a first seal 236 positioned between the translucent portion 230 and a latch housing 234 of the latch assembly 210. In some examples, the first seal 236 is positioned in a recess 240 defined in the latch housing 234 of the latch assembly 210. A second seal 238 is positioned between the translucent portion 230 and the touch member 212. In some examples, the second seal 238 is positioned in a recess 242 defined by the translucent portion 230. A third seal 239 is provided between the latch housing 234 and the translucent portion 230. In some examples, the seals 236, 238, 239 are rubber O-rings and gaskets. However, it is considered within the scope of the present disclosure that the seals 236, 238, 239 can be any of a variety of different types of seals including, but not limited to, sealants, gaskets, or the like.

As shown, the translucent portion 230 is exposed to the front side 220 adjacent to the touch member 212 at a variety of locations. Specifically, the translucent portion 230 includes a first exposed portion 215 and a second exposed portion 217 (also shown in FIGS. 8 and 10). In the depicted example, the first exposed portion 215 forms a rectangular shape at the front side 220 of the lock 200. In the depicted example, the second exposed portion 217 forms a ring around the mechanical lock assembly 222. The first and/or the second exposed portions 215, 217 are configured to expose a light to the user to inform the user of the status of the lock, substantially similar to the translucent portion 130 described above. By way of example, the translucent portion 230, specifically the exposed portion 217, could visually communicate the direction of bolt movement by illuminating regions in sequence to create a rotation animation showing a direction of movement.

Because the translucent portion 230 includes a second exposed portion 217, the third seal 239 is configured to prevent water from gaining access to a cavity 244 that contains a PCB 235 (substantially similar to the cavity 144 and PCB 135 described above). The first and second seals 236, 238 are also configured to prevent water access to the PCB.

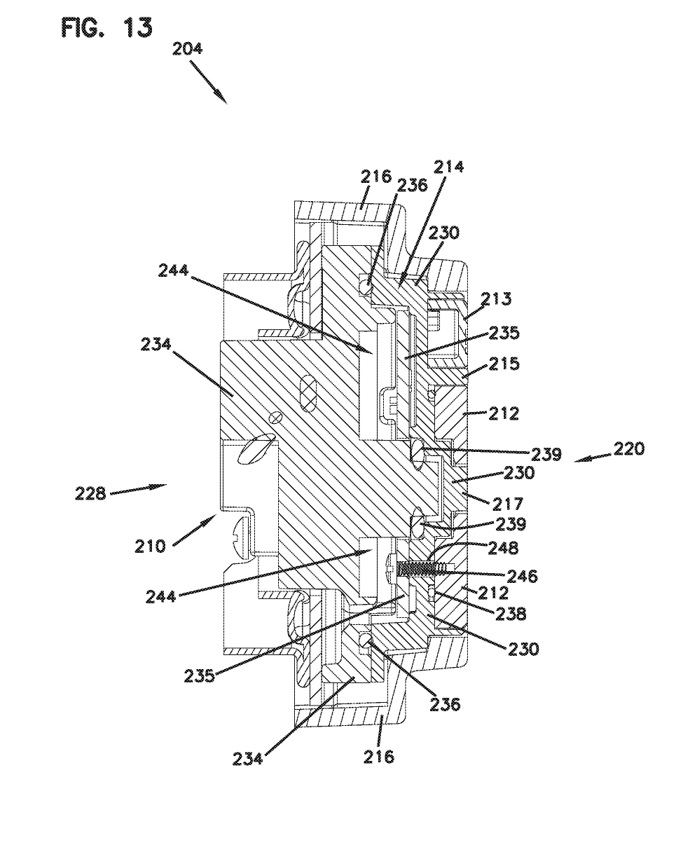

FIG. 13 shows a cross-sectional side view of the lock 200 along the line 13-13 in FIG. 10. As shown, the PCB 235 is positioned within the cavity 244 and electrical communication is shown between the PCB 235 and the touch member 212 via a conductor 246. Like the conductor 146, described above, the conductor 246 passes through an aperture 248 in the translucent portion 230, thereby electrically connecting the touch member 212 and the PCB 235. The aperture 248 is sealed via the first, second, and third seals 236, 238, 239.

The conductor 246 can be any of a variety of conductors to facilitate an electrical connection between the touch member 212 and the PCB 235. With the conductor 246, the PCB 235 can sense when a user touches anywhere on the touch member 212. The conductor 246 could be a conductive fastener, washer/plate embedded within the translucent portion 130, conductive foam, conductive tape, conductive grease, or any other mechanical device electrically connecting the touch member 212 of the lock 200 to the PCB 235 that hosts the touch electronics.

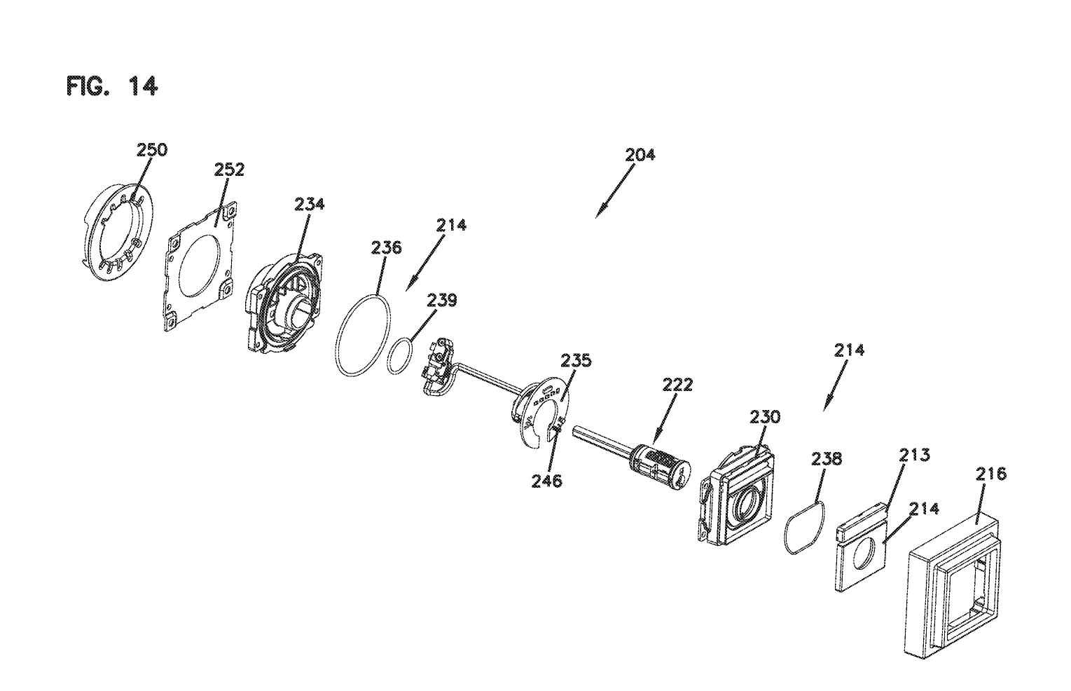

FIG. 14 shows an exploded view of the exterior assembly 204. A pair of mounting brackets 250, 252 are shown. The mounting bracket 250 is configured to aid in connecting the exterior assembly 204 within a door. The mounting bracket 252 can aid in mounting the outer housing 216 to the latch assembly 210, specifically to the latch housing 234.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

We claim:

1. An electronic lock comprising:
a latch assembly having a latch housing and a bolt movable between an extended position and a retracted position;
a controller connected to a circuit board, the circuit board being positioned within an interior cavity, the cavity being at least partially defined by the latch housing, the controller being configured to electronically control movement of the bolt between the extended position and the retracted position;
an exposed conductive touch member, the conductive touch member being in electrical communication with the controller;
an insulating arrangement positioned between the conductive touch member and the circuit board; and
a housing at least partially surrounding the conductive touch member, the housing being electrically isolated from the conductive touch member by at least a portion of the insulating arrangement.

2. The electronic lock of claim 1, further comprising a plurality of seals for weather protection of the circuit board.

3. The electronic lock of claim 1, wherein the housing is isolated from the conductive touch member by at least one seal of the insulating arrangement.

4. The electronic lock of claim 1, wherein the insulating arrangement includes a non-conductive translucent portion.

5. The electronic lock of claim 4, wherein the non-conductive translucent portion includes is co-molded Polycarbonate.

6. The electronic lock of claim 1, further comprising a conductor contacting the circuit board and the conductive touch member.

7. The electronic lock of claim 6, wherein the conductor passes through the insulating arrangement, and wherein the conductor is a fastener.

8. The electronic lock of claim 1, wherein the interior cavity is defined by the insulating arrangement and the latch housing, and wherein the interior cavity is sealed.

9. The electronic lock of claim 8, wherein the insulating arrangement includes a translucent portion and a first and a second seal, wherein the first seal is positioned between the conductive touch member and the translucent portion, and wherein the second seal is positioned between the translucent portion and the latch housing.

10. The electronic lock of claim 9, wherein the insulating arrangement further comprises a third seal positioned between the translucent portion and the latch housing.

11. The electronic lock of claim 1, wherein the controller is configured to electronically control movement of the bolt between the extended position and the retracted position based on a touch input received at the conductive touch member.

12. The electronic lock of claim 1, wherein the housing that electrically isolated from the conductive touch member is generally circular.

13. The electronic lock of claim 1, wherein the housing that electrically isolated from the conductive touch member is generally rectangular.

14. An electronic lock comprising:
a latch assembly having a latch housing and a bolt movable between an extended position and a retracted position;
a controller connected to a circuit board, the circuit board being positioned within an interior cavity, the cavity being at least partially defined by the latch housing, the controller being configured to electronically control movement of the bolt between the extended position and the retracted position;
an exposed conductive touch member, the conductive touch member being in electrical communication with the controller;
an insulating arrangement positioned between the conductive touch member and the circuit board, the insulating arrangement including a translucent portion configured to transmit light and at least one seal, the translucent portion at least partially defining the interior cavity, wherein the translucent portion is at least partially exposed adjacent the touch member, wherein the at least one seal is positioned between at least one of the translucent portion and the latch housing and the translucent portion and the touch member to seal the interior cavity; and
a housing at least partially surrounding the conductive touch member, the housing being electrically isolated from the conductive touch member by at least a portion of the insulating arrangement.

15. The electronic lock of claim 14, wherein the translucent portion is formed of a non-conductive co-molded Polycarbonate.

16. The electronic lock of claim 14, further comprising a conductor contacting the circuit board and the conductive touch member.

17. The electronic lock of claim 16, wherein the conductor passes through the insulating arrangement.

18. An electronic lock comprising:
a latch assembly having a latch housing and a bolt movable between an extended position and a retracted position;
a controller mounted to a circuit board, the circuit board being positioned within an interior cavity, the cavity being at least partially defined by the latch housing, the controller being configured to electronically control movement of the bolt between the extended position and the retracted position;
an exposed conductive touch member, the conductive touch member being in electrical communication with the controller via a conductor;
an insulating arrangement positioned between the conductive touch member and the circuit board, the insulating arrangement including a body at least partially defining the interior cavity, wherein the body defines an aperture configured to receive the conductor, wherein a first seal of the insulating arrangement surrounds the aperture; and
a housing at least partially surrounding the conductive touch member, the housing being electrically isolated from the conductive touch member by at least a portion of the insulating arrangement.

19. The electronic lock of claim 18, wherein the first seal surrounds the aperture at a first side nearest the conductive member.

20. The electronic lock of claim 18, further comprising a second seal surrounding the aperture at a second side nearest the latch housing.

21. The electronic lock of claim 18, wherein the body is translucent and partially exposed adjacent to the touch member.
